(19) United States
(12) Patent Application Publication
(10) Pub. No.: US 2026/0062334 A1
(43) Pub. Date: Mar. 5, 2026

(54) GLASS CHEMICAL STRENGTHENING FURNACE DEVICE AND ELECTRONIC DEVICE INCLUDING OR FORMED WITH THE SAME

(71) Applicant: Samsung Display Co., Ltd., Yongin-si (KR)

(72) Inventors: Jun Yeub LEE, Yongin-si (KR); Sung Won KIM, Yongin-si (KR); Sang Duk LEE, Yongin-si (KR); Hoi Kwan LEE, Yongin-si (KR)

(21) Appl. No.: 19/203,891

(22) Filed: May 9, 2025

(30) Foreign Application Priority Data
Aug. 28, 2024 (KR) 10-2024-0115688

(51) Int. Cl. C03B 27/02; C03B 27/012

(52) U.S. Cl. CPC C03B 27/02; C03B 27/012

(57) ABSTRACT

A glass chemical strengthening furnace device is provided. A glass chemical strengthening furnace device includes, a bath, a first electrode on one side of the bath, and a second electrode on the other side of the bath and opposite to the first electrode. The first electrode is arranged to be separated from the second electrode with the bath therebetween.

### CROSS-REFERENCE TO RELATED APPLICATION

The present application claims priority to and the benefit of Korean Patent Application No. 10-2024-0115688, filed on Aug. 28, 2024, in the Korean Intellectual Property Office, the entire disclosure of which is incorporated herein by reference.

### BACKGROUND

### 1. Field

The present disclosure relates to a glass chemical strengthening furnace device.

### 2. Description of the Related Art

As the information society develops, the demand for display devices for displaying images has increased and diversified. Display devices may include (e.g., be) liquid crystal displays (LCDs), field emission displays (FEDs), and/or light-emitting displays (LEDs). Light-emitting displays may include organic light-emitting displays with organic light-emitting diode elements, inorganic light-emitting displays with inorganic light-emitting diode elements, and/or the like.

As portable electronic device display devices, such as smartphones and/or tablet personal computers (PCs), develop into bendable, foldable, and/or rollable forms, glass articles applied to these devices are also desired or required to have characteristics corresponding to these forms.

As a cover window of a foldable display device, ultra-thin glass has recently been prominent to improve scratch resistance and durability against folding.

### SUMMARY

Aspects of one or more embodiments of the present disclosure provide a glass chemical strengthening furnace device that improves the ion exchange process rate.

Aspects of one or more embodiments of the present disclosure also provide a glass chemical strengthening furnace device capable of increasing a maximum compressive stress and a compressive depth of a glass article.

However, aspects of one or more embodiments of the present disclosure are not restricted to those set forth herein. The above and other aspects of one or more embodiments of the present disclosure will become more apparent to one of ordinary skill in the art to which the present disclosure pertains by referencing the detailed descriptions of the present disclosure.

According to one or more embodiments of the present disclosure, a glass chemical strengthening furnace device may include, a bath, a first electrode arranged on one side of the bath, and a second electrode arranged on the other side of the bath and opposite to (e.g., facing) the first electrode. The first electrode may be arranged to be separated from (e.g., spaced apart from) the second electrode with the bath therebetween (e.g., interposed therebetween).

In one or more embodiments, the glass chemical strengthening furnace device may further include a power supply (e.g., a power supply unit) configured to apply a voltage to the first electrode and the second electrode.

In one or more embodiments, a magnitude of the voltage applied to the first electrode and the second electrode by the power supply is 5 V to 2000 V.

In one or more embodiments, the glass chemical strengthening furnace device may further include a polarity switch (e.g., a polarity switching unit) configured to change a polarity of a voltage applied to the first electrode and the second electrode.

In one or more embodiments, the polarity switch may include at least one of an H-bridge circuit and/or a double-pole double-throw (DP DT) switch.

In one or more embodiments, the first electrode may include a first pattern portion, the second electrode may include a second pattern portion, and the first pattern portion may be opposite to the second pattern portion.

In one or more embodiments, the first pattern portion may be opposite to the second pattern portion with the bath therebetween.

In one or more embodiments, the first pattern portion and the second pattern portion may include a protruding portion and a recessed portion respectively.

In one or more embodiments, the protruding portion of the first pattern portion and the protruding portion of the second pattern portion may be positioned in a straight line.

In one or more embodiments, the protruding portion of the first pattern portion and the protruding portion of the second pattern portion may be staggered.

In one or more embodiments, the protruding portion of the first pattern portion and the recessed portion of the second pattern portion may be positioned in a straight line.

In one or more embodiments, the glass chemical strengthening furnace device may further include a first rotation driver (e.g., a first rotation driving unit) fastened to the first electrode, and a second rotation driver (e.g., a second driving unit) fastened to the second electrode.

In one or more embodiments, an electric field may be between (e.g., formed between) the first electrode and the second electrode.

In one or more embodiments, the bath may include an insulating material (e.g., an insulator) and a dielectric. For example, the bath may be made of an insulating material, and includes a dielectric. For example, the bath may include an insulating material to electrically insulate the first and second electrodes, and a dielectric material to store and manage electrical energy effectively.

In one or more embodiments, the glass chemical strengthening furnace device may further include a heater arranged on a sidewall of the bath.

According to one or more embodiments of the present disclosure, a glass chemical strengthening furnace device may include a bath in which a reaction space is defined, an electric field generator (e.g., an electric field forming unit) configured to form an electric field in the reaction space of the bath, and an electric field controller configured to apply a voltage to the electric field generator. The electric field generator may include a first electrode and a second electrode respectively arranged on both sides (e.g., opposite sides) of the bath.

In one or more embodiments, the electric field controller may include a power supply configured to apply a voltage to the first electrode and the second electrode.

In one or more embodiments, the electric field controller may include a polarity switch configured to change a polarity of the voltage applied to the first electrode and the second electrode.

In one or more embodiments, the first electrode may include a first pattern portion, the second electrode may include a second pattern portion, and the first pattern portion may be opposite to (e.g., face) the second pattern portion.

In one or more embodiments, the glass chemical strengthening furnace device may further include a first rotation driver fastened to the first electrode, and a second rotation driver fastened to the second electrode.

According to one or more embodiments of the present disclosure, an electronic device may include or be formed with a glass chemical strengthening furnace device including: a bath, a first electrode on one side of the bath, and a second electrode on the other side of the bath and opposite to the first electrode. The first electrode may be arranged to be separated from the second electrode with the bath therebetween. For example, the electronic device may include a glass article formed with the glass chemical strengthening furnace device.

According to one or more embodiments of the present disclosure, an ion exchange process rate may be improved utilizing the glass chemical strengthening furnace device.

According to one or more embodiments of the present disclosure, a maximum compressive stress and a compressive depth of a glass article may be increased utilizing the glass chemical strengthening furnace device.

The effects of the present disclosure are not limited to the aforementioned effects, and one or more suitable other effects are included in the present specification. For example, according to one or more embodiments of the present disclosure, an electronic device may include or be formed with a glass chemical strengthening furnace device. This furnace device includes a bath, a first electrode on one side of the bath, and a second electrode on the opposite side. The first electrode is separated from the second electrode by the bath. Here, the electronic device may include a glass article formed using this glass chemical strengthening furnace device. With this furnace device, the ion exchange process rate may be improved, leading to enhanced performance. Additionally, the maximum compressive stress and compressive depth of the glass article may be increased, resulting in stronger and more durable glass.

### BRIEF DESCRIPTION OF THE DRAWINGS

The above and other aspects and features of one or more embodiments of the present disclosure will become more apparent from the following descriptions taken in conjunction with the accompanying drawings, in which:

FIG. 1 is a perspective view illustrating an example in which a glass article is applied as a cover window of a display device according to one or more embodiments;

FIG. 2 is a cross-sectional view illustrating the glass article according to one or more embodiments;

FIG. 3 is a graph illustrating a stress profile of the glass article according to one or more embodiments;

FIG. 4 is a schematic view illustrating an ion exchange process of a chemical strengthening operation (e.g., act or task);

FIG. 5 is a perspective view illustrating a glass chemical strengthening furnace device according to one or more embodiments;

FIG. 6 is a cross-sectional view illustrating the glass chemical strengthening furnace device according to one or more embodiments;

FIG. 7 is a block diagram illustrating an electric field controller according to one or more embodiments;

FIGS. 8 and 9 are schematic views for describing an electric field control method of the electric field controller according to one or more embodiments;

FIG. 10 is a cross-sectional view illustrating a glass chemical strengthening furnace device according to the one or more embodiments;

FIG. 11 is a cross-sectional view illustrating a glass chemical strengthening furnace device according to the one or more embodiments;

FIG. 12 is a cross-sectional view illustrating a glass chemical strengthening furnace device according to the one or more embodiments;

FIG. 13 is a cross-sectional view illustrating a glass chemical strengthening furnace device according to the one or more embodiments;

FIG. 14 is a flowchart illustrating a glass chemical strengthening method according to one or more embodiments;

FIG. 15A is a cross-sectional view illustrating an example of a cassette in S100 of FIG. 14;

FIG. 15B is a plan view illustrating another example of the cassette in S100 of FIG. 14;

FIG. 15C is a cross-sectional view illustrating another example of the cassette in S100 of FIG. 14;

FIG. 16 is a perspective view illustrating S100 of FIG. 14;

FIG. 17 is a perspective view illustrating S200 of FIG. 14;

FIG. 18 is a perspective view illustrating S300 of FIG. 14;

FIG. 19 is a perspective view illustrating S400 of FIG. 14;

FIG. 20 is a perspective view illustrating S500 of FIG. 14; and

FIG. 21 is a schematic view illustrating an ion exchange process in S500 of FIG. 14.

### DETAILED DESCRIPTION

The present disclosure will now be described more fully hereinafter with reference to the accompanying drawings, in which one or more embodiments of present disclosure are shown, and duplicative descriptions thereof may not be provided. The present disclosure may, however, be embodied in different forms and should not be construed as limited to one or more embodiments set forth herein. Rather, these embodiments are provided so that the present disclosure will be thorough and complete, and will filly convey the scope of present disclosure and equivalents thereof to those skilled in the art.

As utilized herein, the term “and/or” includes any and all combinations of one or more of the associated listed items. Throughout the disclosure, the expression “at least one of a, b or c” indicates only a, only b, only c, both (e.g., simultaneously) a and b, both (e.g., simultaneously) a and c, both (e.g., simultaneously) b and c, all of a, b, and c, or variations thereof.

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

While such terms as “first” and “second” may be utilized to describe one or more suitable components, such components must not be limited to the above terms. The above terms are utilized to distinguish one component from another.

The singular forms “a,” “an,” and “the” as utilized herein are intended to include the plural forms as well unless the context clearly indicates otherwise.

It will also be understood that if (e.g., when) an element or layer is referred to as being “on,” “connected to”, “coupled to”, or “adjacent to” another element, layer, or substrate, it can be directly on, connected to, coupled to, or adjacent to the other element, layer, or substrate, or one or more intervening elements, layers, or substrates may also be present. In contrast, when an element or layer is referred to as being “directly on,” “directly connected to”, “directly coupled to”, or “immediately adjacent to” another element or layer, there are no intervening elements or layers present.

The x-axis, the y-axis and the z-axis are not limited to three axes of the rectangular coordinate system, and may be interpreted in a broader sense. For example, the x-axis, the y-axis, and the z-axis may be normal (e.g., perpendicular) to one another, or may represent different directions that are not normal (e.g., perpendicular) to one another.

Hereinafter, one or more embodiments of the present disclosure will be described in more detail with reference to the accompanying drawings, where like reference numerals refer to like elements throughout, and duplicative descriptions thereof may not be provided, and a repeated description thereof is omitted. Sizes of elements in the drawings may be exaggerated or reduced for convenience of explanation. In some embodiments, the size and thickness of each element shown in the drawings are arbitrarily represented for convenience of description, and thus, the disclosure is not necessarily limited thereto. The same reference numeral indicates the same component throughout the specification.

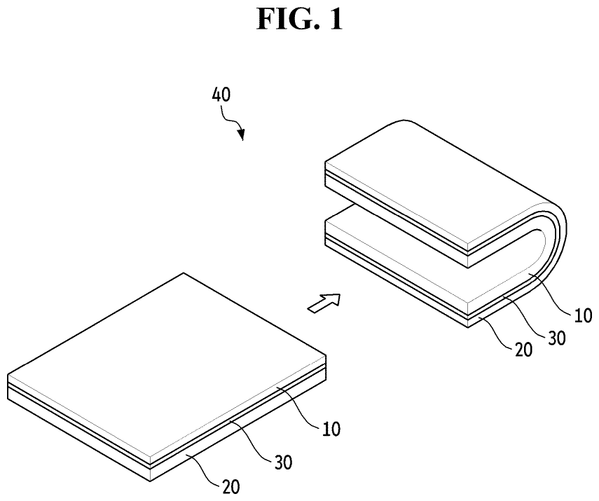

FIG. 1 is a perspective view illustrating an example in which a glass article is applied as a cover window of a display device according to one or more embodiments.

Referring to FIG. 1, a glass is utilized as a cover window for protecting a display device, a substrate for a display panel, a substrate for a touch panel, an optical member such as a light guide plate, and/or the like, in an electronic device including a display device, such as a refrigerator including a display screen and/or a washing machine including a display screen, as well as a tablet personal computer (PC), a laptop computer, a smartphone, an electronic book, a television, and/or a PC monitor. The glass may also be utilized as a cover glass of instrument boards of a vehicle, a cover glass for a solar cels, an interior material of a building material, a window of a building and/or a house, and/or the like.

Some glass articles 10 are desired or required to have high strength. For example, a glass article 10 for a cover window may have strength enough to be not easily damaged by an external shock while having a small thickness to satisfy requirements of high transmissivity and a light weight. A glass article 10 whose strength is increased may be manufactured by a chemical strengthening method including an ion exchange process.

A “glass article” as utilized herein refers to an article made entirely of a glass or partially including a glass.

An example in which a glass article 10 is applied as a cover window of a display device 40 is illustrated in FIG. 1. As illustrated in FIG. 1, the display device 40 may include a display panel 20, the glass article 10 arranged on (e.g., disposed on or above) the display panel 20, and an optical clear coupling layer 30 arranged between (e.g., disposed between) the display panel 20 and the glass article 10 and coupling the display panel 20 and the glass article 10 to each other.

The display device 40 according to one or more embodiments may be a foldable display device 40. However, the present disclosure is not limited thereto. The display panel 20 utilized in the foldable display device 40 may be a flexible panel of which at least a portion may be folded.

The display panel 20 may include, for example, not only a self-light emitting display panel such as an organic light emitting display panel, an inorganic light emitting display panel, a quantum dot light emitting display panel, a micro light emitting diode (LED) display panel, a nano LED display panel, a plasma display panel, a field emission display panel, and/or a cathode ray display panel, but also a light-receiving display panel such as a liquid crystal display panel and/or an electrophoretic display panel.

The display panel 20 may include a plurality of pixels, and may display an image utilizing light emitted from each pixel. The display device 40 may further include a touch member. In one or more embodiments, the touch member may be embedded in the display panel 20. For example, the touch member is directly formed on a display member of the display panel 20, such that the display panel 20 itself may perform a touch function. In one or more embodiments, the touch member may be manufactured separately from the display panel 20 and then attached to an upper surface of the display panel 20 by an optical clear coupling layer.

The glass article 10 is arranged above (e.g., disposed above or on) the display panel 20. The glass article 10 protects the display panel 20 above the display panel 20. The glass article 10 utilized as the cover window of the foldable display device 40 may be an ultra-thin glass. The ultra-thin glass may have a thickness of about 300 μm or less, or about 100 μm or less, but the present disclosure is not limited thereto.

The optical clear coupling layer 30 is arranged between (e.g., disposed between) the display panel 20 and the glass article 10. The optical clear coupling layer 30 serves to fix the glass article 10 onto the display panel 20. The optical clear coupling layer 30 may include an optical clear adhesive (OCA), an optical clear resin (OCR), and/or the like. If (e.g., when) the display device 40 is folded, the glass article 10 and the optical clear coupling layer 30 may be folded in a shape corresponding to the display panel 20.

Hereinafter, the glass article 10 strengthened as described above will be described in more detail.

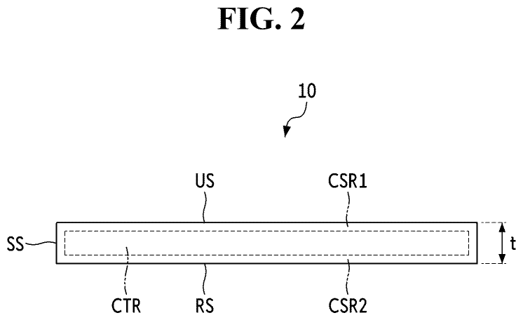

FIG. 2 is a cross-sectional view illustrating the glass article according to one or more embodiments.

Referring to FIG. 2, the glass article 10 includes a plurality of surfaces US, RS, and SS. The surfaces of the glass article may include a first surface US, a second surface RS, and side surfaces SS. In the glass article 10 having a flat panel plate shape (e.g., in a form of plates), the first surface US and the second surface RS are main surfaces (e.g., an upper surface and a lower surface) having a great area, and the side surfaces SS are outer surfaces connecting the first surface US and the second surface RS to each other.

The first surface US and the second surface RS oppose each other in a thickness t direction. If (e.g., when) the glass article 10 serves to transmit light like the cover window of the display device, the light may mainly enter the first surface US or the second surface RS and be transmitted through the other of the first surface US or the second surface RS. For example, if (e.g., when) the light enters the first surface US, the light may be transmitted through the second surface RS.

A thickness t of the glass article 10 is defined as a distance between the first surface US and the second surface RS. The glass article 10 may be an ultra-thin glass. The thickness t of the glass article 10 may be in the range of 10 μm to 300 μm, but the present disclosure is not limited thereto. The glass article 10 may have a substantially uniform thickness t, but the present disclosure is not limited thereto, and may have different thicknesses for each region.

The glass article 10 includes compressive regions CSR1 and CSR2 and a tensile region CTR. The compressive regions CSR1 and CSR2 are regions where a compressive stress acts, and the tensile region CTR is a region where a tensile stress acts. The compressive regions CSR1 and CSR2 may be arranged adjacent to the surfaces US, RS, and SS of the glass article 10, and the tensile region CTR may be at (e.g., arranged in) an inner region (or a central region) of the glass article 10. The compressive regions CSR1 and CSR2 may be arranged adjacent to the side surfaces SS as well as to the first surface US and the second surface RS. A depth (compressive depth) of the compressive regions CSR1 and CSR2 extending from each of the surfaces US, RS, and SS in a depth direction may be substantially uniform, but the present disclosure is not limited thereto. The tensile region CTR may be surrounded by the compressive regions CSR1 and CSR2.

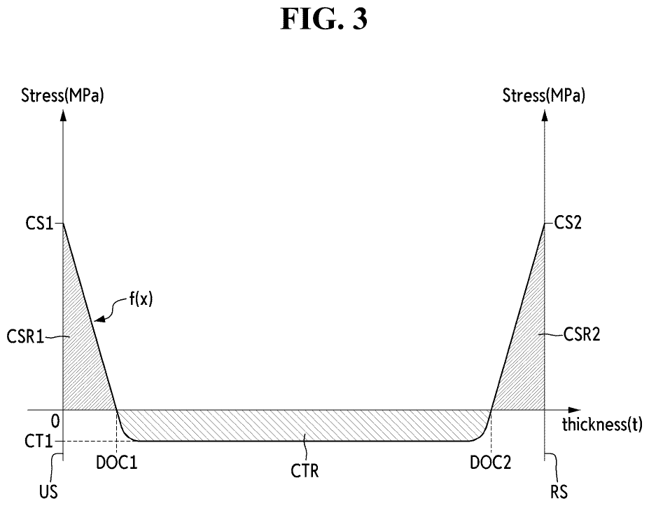

FIG. 3 is a graph illustrating a stress profile of the glass article according to one or more embodiments. In the graph of FIG. 3, an x axis indicates the thickness t direction of the glass article 10. In FIG. 3, the compressive stress is expressed as a positive value and the tensile stress is expressed as a negative value. A magnitude of the compressive/tensile stress as utilized herein refers to a magnitude of an absolute value regardless of a sign of a value of the compressive/tensile stress.

Referring to FIG. 3 in addition FIGS. 1 and 2, the glass article 10 includes a first compressive region CSR1 extending from the first surface US to a first depth (first compressive depth) DOC1 and a second compressive region CSR2 extending from the second surface RS to a second depth (second compressive depth) DOC2. The tensile region CTR is arranged between the first compressive depth DOC1 and the second compressive depth DOC2. In one or more embodiments, compressive regions and a tensile region may be arranged between opposing side surfaces SS of the glass article 100 in a similar manner.

The first compressive region CSR1 and the second compressive region CSR2 resist an external shock to alleviate the occurrence of cracks in the glass article 10 or damage to the glass article 10. It may be understood that the greater the maximum compressive stresses CS1 and CS2 of the first and second compressive regions CSR1 and CSR2, the greater the strength of the glass article 10. Because the external shock is normally transferred through the surfaces US, RS, and SS of the glass article 10, it is advantageous in terms of durability to have the maximum compressive stresses CS1 and CS2 on the surfaces US, RS, and SS of the glass article 10.

The first compressive depth DOC1 and the second compressive depth DOC2 prevent or reduce cracks or grooves formed in the surfaces US, RS, and SS from propagating into the tensile region CTR inside the glass article 10. As the compressive depths DOC1 and DOC2 become greater, the propagation of the cracks and/or the like may be prevented or reduced better.

The graph of FIG. 3 is a stress profile of a region crossing the first surface US and the second surface RS in the thickness direction. Because an ion exchange similar to an ion exchange occurring in the first surface US and the second surface RS may occur in the side surface SS, a stress profile similar to that of the first compressive region CSR1 may appear in the side surface SS.

Stress energy accumulated in one region having a constant width in the thickness t direction in the glass article 10 may be calculated as a value obtained by integrating a stress profile. If (e.g., when) the stress profile in the glass article 10 having the thickness t is expressed as a function f(x), Equation 1 may be satisfied.

$${\int }_{0}^{t} f ( x ) dx = 0 \qquad Equation 1$$

For example, in the stress profile illustrated in FIG. 3, the sum of an area of a region corresponding to the first compressive region CSR1 and an area of a region corresponding to the second compressive region CSR2 may be substantially the same as an area of a region corresponding to the tensile region CTR.

Throughout the glass article 10, the tensile stress of the tensile region CTR may be balanced with the compressive stresses of the compressive regions CSR1 and CSR2. For example, the sum (e.g., compressive energy) of the compressive stresses and the sum (e.g., tensile energy) of the tensile stresses in the glass article 10 may be the same as each other. For example, the sum (e.g., first compressive energy) of the compressive stresses of the first compressive region CSR1 and the sum (e.g., second compressive energy) of the compressive stresses of the second compressive region CSR2 may be the same as the sum (e.g., tensile energy) of the tensile stresses of the tensile region CTR.

The first compressive depth DOC1 and the second compressive depth DOC2 prevent or reduce cracks or grooves formed in the first surface US and the second surface RS from propagating into the tensile region CTR inside the glass article 10. As the first compressive depth DOC1 and the second compressive depth DOC2 become greater, the propagation of the cracks and/or the like may be prevented better or reduced better. Points corresponding to the first compressive depth DOC1 and the second compressive depth DOC2 correspond to the boundaries between the compressive regions CSR1 and CSR2 and the tensile region CTR, and have a stress value of 0. The stress profile as illustrated in FIG. 3 may be formed through an ion exchange process of a chemical strengthening step/operation (e.g., act or task).

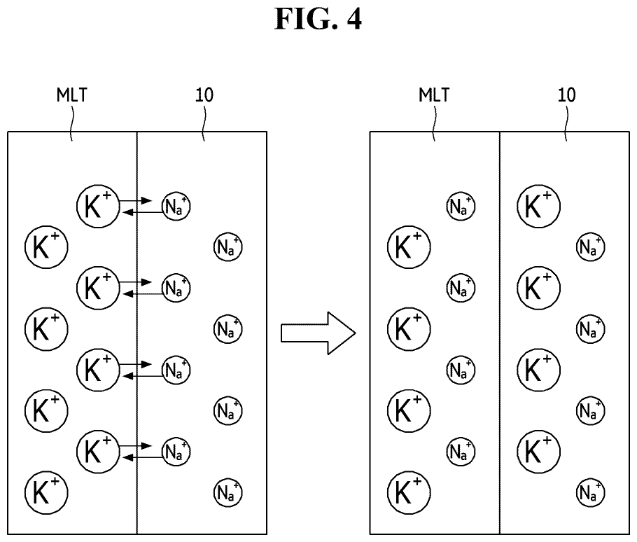

FIG. 4 is a schematic view illustrating an ion exchange process of a chemical strengthening step/operation (e.g., act or task).

Referring to FIG. 4 in addition to FIGS. 1 to 3, the ion exchange process is a process of exchanging ions inside the glass article 10 with other ions. Through the ion exchange process, ions on or near the surfaces US, RS, and SS of the glass article 10 may be replaced or exchanged with greater ions having the same valence or oxidation state.

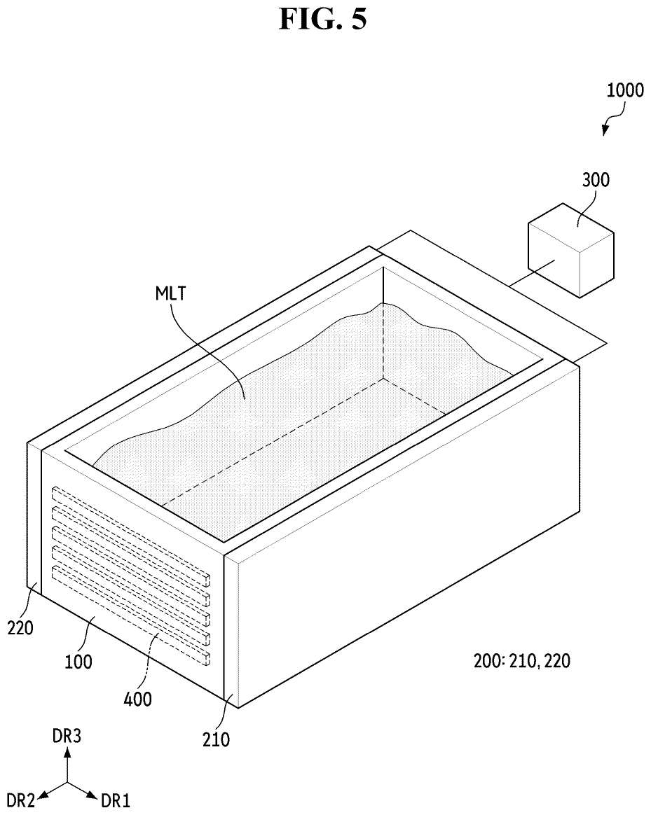

In one or more embodiments illustrated in FIG. 4, an ion exchange process in which the glass article 10 including sodium ions Na⁺ is exposed to potassium ions K⁺ is illustrated. For example, if (e.g., when) the glass article 10 including the sodium ions Na⁺ is immersed in a potassium nitrate (KNO₃) molten salt MLT accommodated in a glass chemical strengthening furnace device 1000 (see FIG. 5) and exposed to the potassium ions K⁺, the sodium ions Na⁺ inside the glass article 10 may be discharged to the outside and replaced with the potassium ions K⁺. The exchanged potassium ions K⁺ have a greater ionic radius than the sodium ions Na⁺ and thus generate a compressive stress. The greater the amount of the exchanged potassium ions K⁺, the greater the compressive stress. Because an ion exchange occurs through the surfaces US, RS, and SS of the glass article 10, an amount of the potassium ions K⁺ on the surfaces US, RS, and SS of the glass article 10 may be the greatest. Some of the exchanged potassium ions K⁺ may increase depths of the compressive regions, for example, the compressive depths DOC1 and DOC2, while diffusing into the inside of the glass article 10, but an amount of the potassium ions K⁺ may substantially decrease as distances from the surfaces US, RS, and SS increase. Accordingly, the glass article 10 may have a stress profile in which the compressive stresses CS1 and CS2 of the surfaces US, RS, and SS are the greatest and decrease toward the inside of the glass article 10. However, one or more embodiments are not limited to that described above, and the stress profile may be modified depending on a temperature, a time, the number of times, presence or absence of heat treatment, and/or the like of the ion exchange process.

In one or more embodiments, if (e.g., when) the glass article 10 is utilized in the foldable display device 40, the glass article 10 having a low modulus may be utilized to improve foldability. The modulus as utilized herein may refer to a Young's modulus, which is measured utilizing a universal testing machine (UTM) (available from Instron Corp.) at room temperature (approximately 20° C. to 30° C.). The glass article 10 having the low modulus may be referred to as a low Young's modulus glass article 10. In one or more embodiments, a Young's modulus of the low Young's modulus glass article 10 may be less than 60 GPa.

The low Young's modulus glass article 10 may have a higher borosilicate ratio than a glass article 10 having a relatively high Young's modulus to lower the modulus. For this reason, the low Young's modulus glass article 10 may have a lower ratio of sodium ions Na⁺ than the glass article 10 having the relatively high Young's modulus, and thus, may require a longer chemical strengthening time and have lower maximum compressive stresses CS1 and CS2 and lower compressive depths DOC1 and DOC2 than the glass article 10 having the relatively high Young's modulus.

For example, if (e.g., when) a sample of the glass article 10 having a thickness t of 1 mm is chemically strengthened for 4 hours, a high Young's modulus glass article 10 having a Young's modulus of approximately 70 GPa may have maximum compressive stresses CS1 and CS2 of approximately 1000 MP a and compressive depths DOC1 and DOC2 of approximately 40 μm, whereas a low Young's modulus glass article 10 having a Young's modulus of approximately 54 GPa may have maximum compressive stresses CS1 and CS2 of approximately 220 MP a and compressive depths DOC1 and DOC2 of approximately 1 μm. However, such numerical values are only examples, and the Young's modulus, the maximum compressive stresses CS1 and CS2, and the compressive depths DOC1 and DOC2 of the glass article 10 are not limited thereto.

Hereinafter, a glass chemical strengthening furnace device 1000 (see FIG. 5) for improving the maximum compressive stresses CS1 and CS2 and the compressive depths DOC1 and DOC2 of the low Young's modulus glass article 10 will be described.

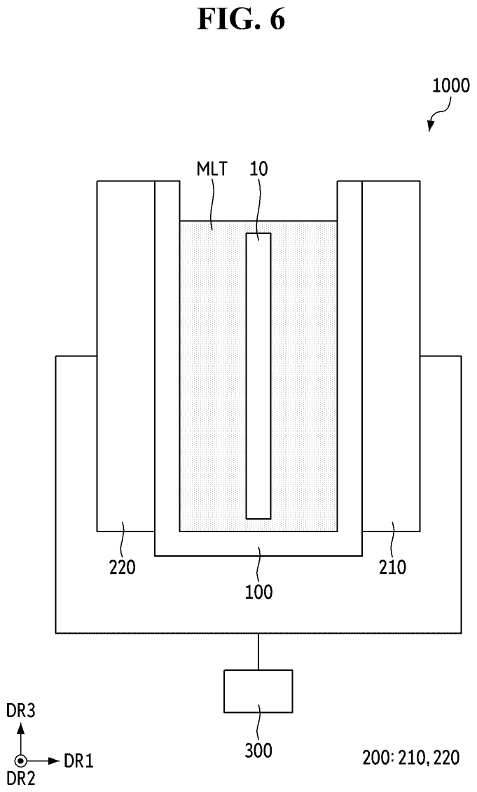

FIG. 5 is a perspective view illustrating a glass chemical strengthening furnace device according to one or more embodiments. FIG. 6 is a cross-sectional view illustrating the glass chemical strengthening furnace device according to one or more embodiments.

Referring to FIGS. 5 and 6 in addition to FIG. 3, a glass chemical strengthening furnace device 1000 is an apparatus of chemically strengthening an ultra-thin glass, and is utilized to chemically strengthen the ultra-thin glass through, for example, an ion exchange process. The glass chemical strengthening furnace device 1000 may perform chemical strengthening by immersing the ultra-thin glass in a molten salt MLT.

In one or more embodiments, the molten salt MLT may include at least one of sodium (Na), potassium (K), rubidium (Rb), and/or cesium (Cs) ions. In one or more embodiments, the molten salt MLT may include potassium nitrate (KNO₃). In one or more embodiments, the molten salt MLT may further include sodium nitrate (NaNO₃) together with potassium nitrate (KNO₃). The sodium nitrate may serve as a catalyst improving an ion exchange rate in the ion exchange process. As an example of chemical strengthening, an example of immersing an ultra-thin glass in the molten salt MLT including potassium nitrate (KNO₃) will hereinafter be illustrated, but the present disclosure is not limited thereto.

The glass chemical strengthening furnace device 1000 may include a bath 100, an electric field generator 200, an electric field controller 300, and a heater 400.

The bath 100 may include a bottom portion and sidewalls. The bath 100 may define a reaction space in the glass chemical strengthening furnace device 1000. For example, the reaction space in the glass chemical strengthening furnace device 1000 may be surrounded by the bottom portion and the sidewalls of the bath 100. The molten salt MLT and the ultra-thin glass to be chemically strengthened may be at (e.g., arranged in) the reaction space. Although not illustrated in FIGS. 5 and 6, the bath 100 may further include a top portion opposing the bottom portion.

It has been illustrated in FIG. 5 that the bath 100 has a rectangular parallelepiped shape, but the present disclosure is not limited thereto. A size and a shape of the bath 100 may be suitably modified depending on a size and a shape of the ultra-thin glass to be chemically strengthened.

In one or more embodiments, the bath 100 may include (e.g., be made of) an insulating material (e.g., an insulator). For example, the bath 100 may be made of an insulating material (e.g., an insulator) so as to be electrically insulated from a first electrode 210 and a second electrode 220 to be described in more detail later. In one or more embodiments, the bath 100 may include a dielectric material. For example, in one or more embodiments, the bath 100 may also include a dielectric material. Dielectric materials, while also being insulators, have the additional property of being able to store electrical energy through polarization. This refers to that the bath 100, when including a dielectric material, may enhance the performance of the glass chemical strengthening process by storing and managing electrical energy more effectively.

The electric field generator 200 may form an electric field by receiving a voltage applied from the electric field controller 300. The electric field generator 200 may generate/form an electric field in the reaction space positioned inside the bath 100 to improve an ion exchange rate in the ion exchange process.

The electric field generator 200 may include a first electrode 210 and a second electrode 220. The first electrode 210 and the second electrode 220 may be opposite to each other (e.g., face each other) in one direction. For example, the first electrode 210 is opposite to the second electrode 220. The first electrode 210 and the second electrode 220 may be arranged on one sidewall of the bath 100 and the other sidewall of the bath 100 opposing the one sidewall, respectively.

It has been illustrated in FIGS. 5 and 6 that the first electrode 210 and the second electrode 220 are arranged on sidewalls of left and right sides of the bath 100 (e.g., one side and the other side of the bath 100 in a first direction DR1), respectively, but the present disclosure is not limited thereto. For example, the first electrode 210 and the second electrode 220 may be arranged on sidewalls of front and rear sides of the bath 100 (e.g., one side and the other side of the bath 100 in a second direction DR2), respectively, or may be arranged on sidewalls (e.g., the bottom portion and the top portion described above) of upper and lower sides of the bath 100 (e.g., one side and the other side of the bath 100 in a third direction DR3), respectively. The first electrode 210 and the second electrode 220 may be positioned anywhere on any two sidewalls of the bath 100 opposing each other.

In the drawings, the first direction DR1 and the second direction DR2 are horizontal directions, respectively, and cross each other. For example, the first direction DR1 and the second direction DR2 may be orthogonal to each other. In addition, the third direction DR3 may be a normal (e.g., perpendicular) direction crossing, for example, orthogonal to, the first direction DR1 and the second direction DR2. Unless otherwise defined, directions indicated by arrows of the first to third directions DR1, DR2, and DR3 may be referred to as one side, and directions opposite to one side may be referred to as the other side. In addition, the terms “on”, “upper side”, “upper portion”, “top portion”, and “upper surface” as utilized herein refer to a direction toward which an arrow of the third direction DR3 is directed in the drawings, and the terms “below”, “lower side”, “lower portion”, “bottom portion”, and “lower surface” utilized as herein refer to a direction opposite to the direction toward which the arrow of the third direction DR3 is directed in the drawings. Voltages having different polarities may be applied to the first electrode 210 and the second electrode 220. As an example, if (e.g., when) a voltage having a positive (+) polarity is applied to the first electrode 210, a voltage having a negative (−) polarity may be applied to the second electrode 220. As another example, if (e.g., when) a voltage having a negative (−) polarity is applied to the first electrode 210, a voltage having a positive (+) polarity may be applied to the second electrode 220.

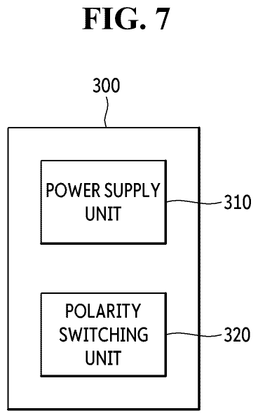

The electric field controller 300 may apply voltages to the electric field generator 200 and change polarities of voltages of the electric field generator 200. For example, the electric field controller 300 may apply voltages having different polarities to the first electrode 210 and the second electrode 220 of the electric field generator 200, and may change the polarities of the voltages applied to the first electrode 210 and the second electrode 220 according to a set or predetermined condition. The electric field controller 300 will be described in more detail later in more detail with reference to FIG. 7 and/or the like.

The heater 400 may be arranged inside the sidewalls of the bath 100.

However, the present disclosure is not limited thereto, and the heater 400 may be arranged inside the bottom portion or the top portion of the bath 100, arranged on the bottom portion, the top portion, inner side surfaces or outer side surfaces of the sidewalls of the bath 100, or integrated with the bottom portion, the top portion, or the sidewalls of the bath 100. As illustrated in FIG. 5, a plurality of heaters 400 may be arranged, but are not limited thereto.

The heater 400 may generate heat desired or required for heat treatment. The heater 400 may be provided as a heating means, such as a heating wire and/or a thermoelectric element having resistance. During the ion exchange process, a solid salt may be provided inside the glass chemical strengthening furnace device 1000, and the heat provided from the heater 400 may melt the solid salt and maintain a temperature of the molten salt MLT.

Furthermore, the heat provided from the heater 400 may maintain the temperature of the molten salt MLT by convecting the molten salt MLT. An arrival amount of the heat generated from the heater 400 may substantially decrease as a distance from the heater 400 increases. A temperature of the molten salt MLT is high in a region close to the heater 400 and decreases as the distance from the heater 400 increases, such that a temperature difference may occur. In this case, a convection phenomenon in which the molten salt MLT having a relatively high temperature rises upward and the molten salt MLT having a low temperature falls downward may be induced. Through such convection of the molten salt MLT, a temperature of the entire molten salt MLT inside the glass chemical strengthening furnace device 1000 may be kept constant.

The solid salt may be arranged inside the glass chemical strengthening furnace device 1000. The solid salt inside the glass chemical strengthening furnace device 1000 may be heated by the heater 400 to become the molten salt MLT. If (e.g., when) the ultra-thin glass is immersed in the molten salt MLT inside the glass chemical strengthening furnace device 1000, the ultra-thin glass is chemically strengthened while the ion exchange process is performed, such that the glass article 10 may be formed.

During the ion exchange process, if (e.g., when) the electric field controller 300 applies the voltages to the electric field generator 200 and the electric field is generated/formed in the reaction space of the bath 100 by the electric field generator 200, the ion exchange rate of the ion exchange process may be improved. Accordingly, the maximum compressive stresses CS1 and CS2 and the compressive depths DOC1 and DOC2 of the low Young's modulus glass article 10 may be improved.

In one or more embodiments, the glass article 10 formed by the glass chemical strengthening furnace device 1000 according to one or more embodiments may be the low Young's modulus glass article 10 having the Young's modulus less than 60 GPa, and may have the maximum compressive stresses CS1 and CS2 of 500 MP a or more.

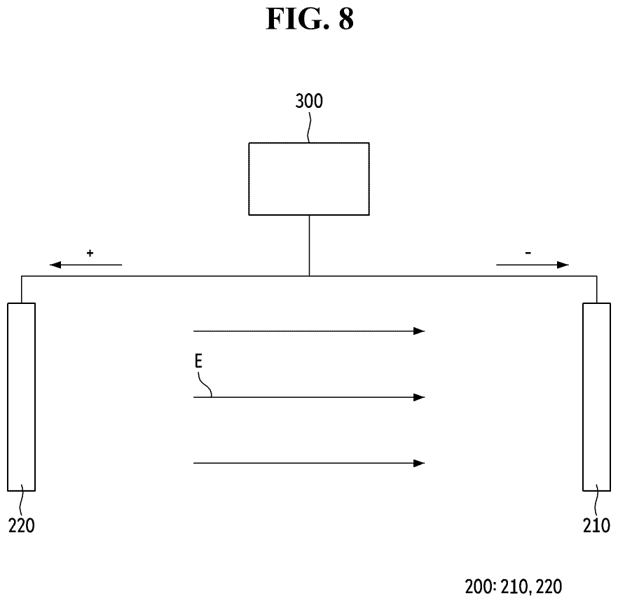

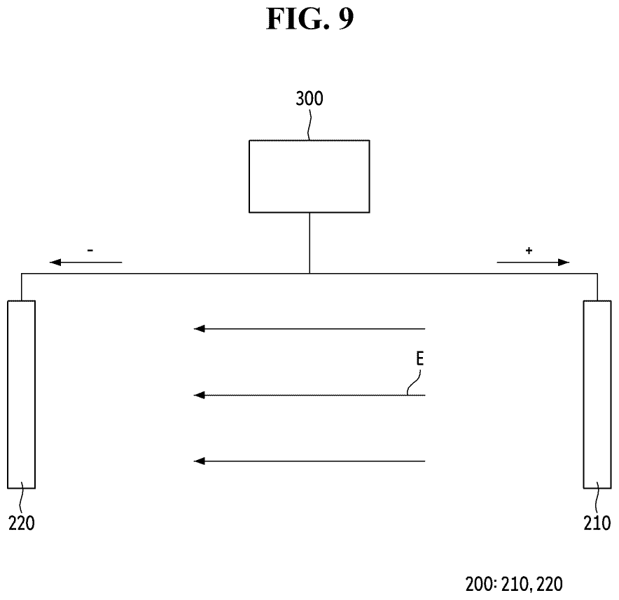

FIG. 7 is a block diagram illustrating an electric field controller according to one or more embodiments. FIGS. 8 and 9 are schematic views for describing an electric field control method of the electric field controller according to one or more embodiments.

Referring to FIGS. 7 to 9 in addition to FIGS. 5 and 6, the electric field controller 300 may include a power supply 310 and a polarity switch 320.

The power supply 310 may apply the voltages to the electric field generator 200. For example, the power supply 310 may apply the voltages to the first electrode 210 and the second electrode 220. In one or more embodiments, a magnitude of the voltages applied to the first electrode 210 and the second electrode 220 by the power supply 310 may be approximately (about) 5 V to (about) 2000 V. Here, the magnitude of the voltages applied to the first electrode 210 and the second electrode 220 by the power supply 310 refers to a voltage difference between the voltages applied to the first electrode 210 and the second electrode 220.

The polarity switch 320 may change the polarities of the voltages applied to the first electrode 210 and the second electrode 220. For example, as illustrated in FIGS. 8 and 9, a negative (−) voltage may be applied to the first electrode 210 and a positive (+) voltage may be applied to the second electrode 220, and then a positive (+) voltage may be applied to the first electrode 210 and a negative (−) voltage may be applied to the second electrode 220 by the polarity switch 320. Accordingly, a direction of an electric field E directed from the second electrode 220 to the first electrode 210 may be changed to be directed from the first electrode 210 to the second electrode 220. Accordingly, the electric field E may evenly act on all surfaces of the ultra-thin glass to be chemically strengthened, such that the ion exchange rate of the ion exchange process may be evenly promoted.

In one or more embodiments, the polarity switch 320 may include at least one of an H-bridge circuit and/or a double-pole double-throw (DP DT) switch.

A polarity change action of the polarity switch 320 may be performed automatically or manually (by an operation/manipulation of a user, and/or the like) depending on one or more suitable conditions such as a process execution time and an execution speed of the ion exchange process.

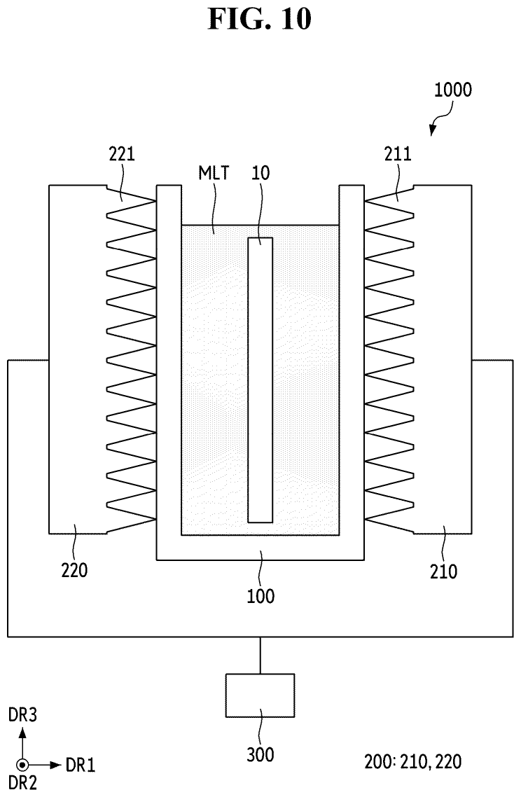

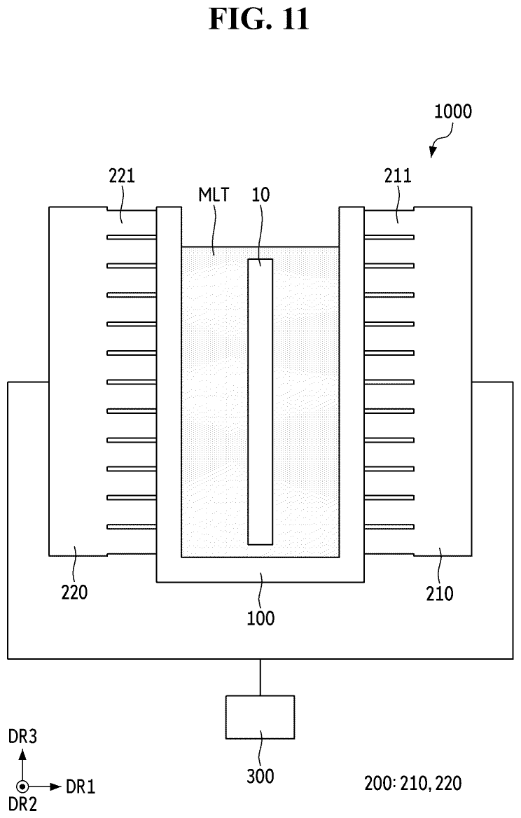

Hereinafter, one or more embodiments of the glass chemical strengthening furnace device will be described. In one or more embodiments described with reference to FIGS. 10 and 11, the same components as those of the above-described embodiment will be denoted by the same reference numerals, and an overlapping description thereof will not be provided or simplified and contents different from those described above will be mainly described.

FIG. 10 is a cross-sectional view illustrating a glass chemical strengthening furnace device according to one or more embodiments. FIG. 11 is a cross-sectional view illustrating a glass chemical strengthening furnace device according to still one or more embodiments.

Referring to FIGS. 10 and 11, a glass chemical strengthening furnace device 1000 according to one or more embodiments described with reference to FIGS. 10 and 11 is different from the glass chemical strengthening furnace device 1000 according to one or more embodiments described with reference to FIG. 6 in that it further includes pattern portions 211 and 221.

More specifically, the first electrode 210 and the second electrode 220 of the electric field generator 200 may include the pattern portions 211 and 221, respectively. For example, the first electrode 210 may include a first pattern portion 211, and the second electrode 220 may include a second pattern portion 221.

The first pattern portion 211 and the second pattern portion 221 may be arranged to face each other. For example, the first pattern portion 211 and the second pattern portion 221 may be positioned on opposite sides with the bath 100 interposed therebetween, and be arranged to be opposite to (e.g., face) each other. In one or more embodiments, protruding portions of the first pattern portion 211 and protruding portions of the second pattern portion 221 may be positioned in straight lines along the first direction DR1 (e.g., the horizontal direction).

The first pattern portion 211 and the second pattern portion 221 may each have a shape in which they protrude toward the bath 100. In one or more embodiments, as illustrated in FIG. 10, the first pattern portion 211 and the second pattern portion 221 may each have a triangular tip shape in a cross section. In one or more embodiments, as illustrated in FIG. 11, the first pattern portion 211 and the second pattern portion 221 may each have a rectangular rugged pattern shape in a cross section. However, the present disclosure is not limited thereto, and although not illustrated in FIGS. 10 and 11, the first pattern portion 211 and the second pattern portion 221 may each have a semicircular or semi-elliptical shape and/or other shapes in a cross section.

The glass chemical strengthening furnace device 1000 according to one or more embodiments described with reference to FIGS. 10 and 11 may increase intensity of the electric field generated/formed by the electric field generator 200 by including the first pattern portion 211 and the second pattern portion 221.

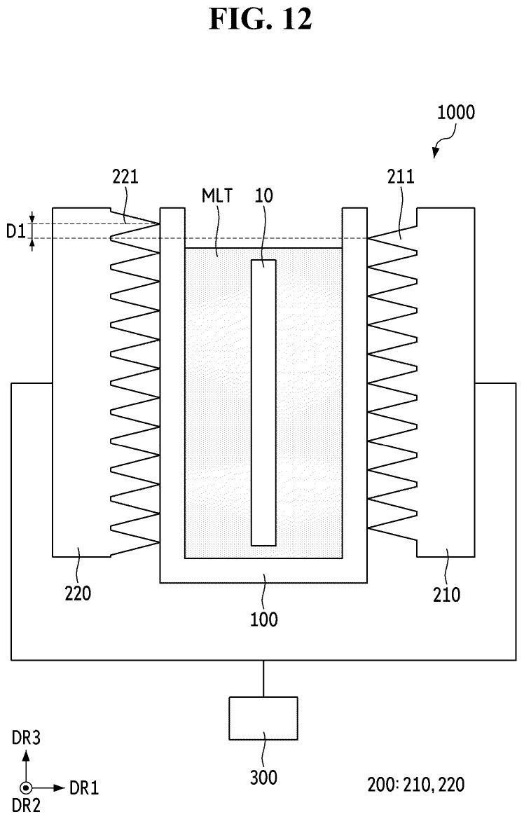

FIG. 12 is a cross-sectional view illustrating a glass chemical strengthening furnace device according to still one or more embodiments.

Referring to FIG. 12, a glass chemical strengthening furnace device 1000 according to one or more embodiments described with reference to FIG. 12 is different from the glass chemical strengthening furnace device 1000 according to one or more embodiments described with reference to FIG. 10 in that protruding portions of the first pattern portion 211 and the second pattern portion 221 are staggered.

More specifically, the protruding portions of the first pattern portion 211 and the protruding portions of the second pattern portion 221 may be staggered in the third direction DR3. For example, the protruding portions of the first pattern portion 211 may be positioned in straight lines with recessed portions of the second pattern portion 221 in the first direction DR1 (e.g., the horizontal direction), and the protruding portions of the second pattern portion 221 may be positioned in straight lines with recessed portions of the first pattern portion 211 in the first direction DR1 (e.g., the horizontal direction). For example, the protruding portions of the first pattern portion 211 and the protruding portions of the second pattern portion 221 may be staggered by a first distance D1 in the third direction DR3.

In the glass chemical strengthening furnace device 1000 according to one or more embodiments described with reference to FIG. 12, the protruding portions of the first pattern portion 211 and the protruding portions of the second pattern portion 221 are staggered in the third direction DR3, such that an electric field may be generated/formed in a diagonal direction defined by the first direction DR1 and the third direction DR3. The ion exchange rate of the ion exchange process may be evenly promoted by the diversification of the direction of the electric field as described above.

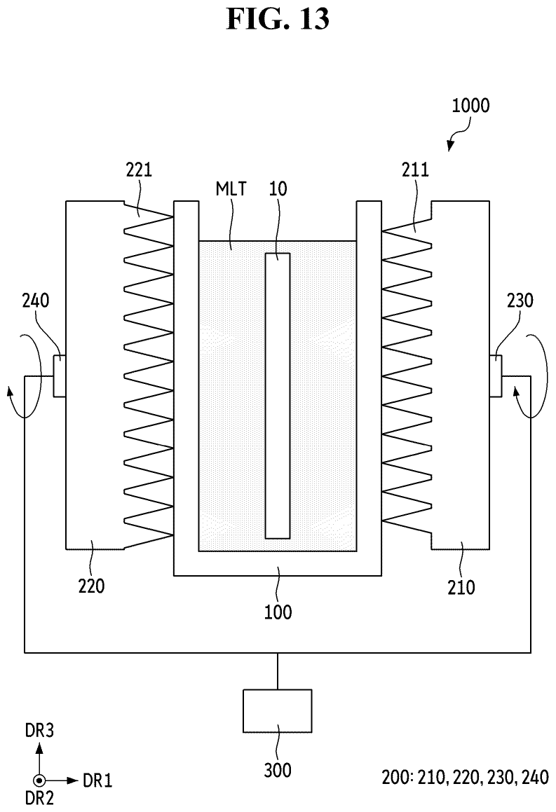

FIG. 13 is a cross-sectional view illustrating a glass chemical strengthening furnace device according to still one or more embodiments.

Referring to FIG. 13, a glass chemical strengthening furnace device 1000 according to one or more embodiments described with reference to FIG. 13 is different from the glass chemical strengthening furnace device 1000 according to still one or more embodiments described with reference to FIG. 12 in that it further includes rotation drivers 230 and 240.

More specifically, the electric field generator 200 may further include the rotation drivers 230 and 240. For example, the electric field generator 200 may include a first rotation driver 230 rotating the first electrode 210 and a second rotation driver 240 rotating the second electrode 220.

The first rotation driver 230 may be arranged on one side of the first electrode 210, and the second rotation driver 240 may be arranged on one side of the second electrode 220. For example, the first rotation driver 230 may be arranged on one side surface of the first electrode 210 in the first direction DR1, and the second rotation driver 240 may be arranged on the other side surface of the second electrode 220 in the first direction DR1.

The first rotation driver 230 and the second rotation driver 240 may be fastened to the first electrode 210 and the second electrode 220, respectively, to rotate the first electrode 210 and the second electrode 220, respectively. In one or more embodiments, as illustrated in FIG. 13, the first rotation driver 230 and the second rotation driver 240 may rotate the first electrode 210 and the second electrode 220 in substantially the same direction, respectively, but are not limited thereto. As an example, the first rotation driver 230 and the second rotation driver 240 may rotate the first electrode 210 and the second electrode 220 in different directions, respectively. As another example, if (e.g., when) the first rotation driver 230 rotates the first electrode 210, the second rotation driver 240 may not rotate the second electrode 220, or if (e.g., when) the second rotation driver 240 rotates the second electrode 220, the first rotation driver 230 may not rotate the first electrode 210.

In the glass chemical strengthening furnace device 1000 according to one or more embodiments described with reference to FIG. 13, the first rotation driver 230 and the second rotation driver 240 rotate the first electrode 210 and the second electrode 220, respectively, such that a relative disposition of the protruding portions of the first pattern portion 211 and the protruding portions of the second pattern portion 221 may continuously change. Accordingly, the ion exchange rate of the ion exchange process may be evenly promoted by the diversification of the direction of the electric field.

It has been illustrated by way of example in FIG. 13 that the rotation drivers 230 and 240 are further included in the glass chemical strengthening furnace device 1000 according to still one or more embodiments described with reference to FIG. 12, but the present disclosure is not limited thereto. For example, the rotation drivers 230 and 240 may also be included in the glass chemical strengthening furnace devices 1000 according to one or more embodiments described above with reference to FIGS. 6, 10, and 11.

Hereinafter, a method of chemically strengthening a glass article utilizing the glass chemical strengthening furnace device will be described.

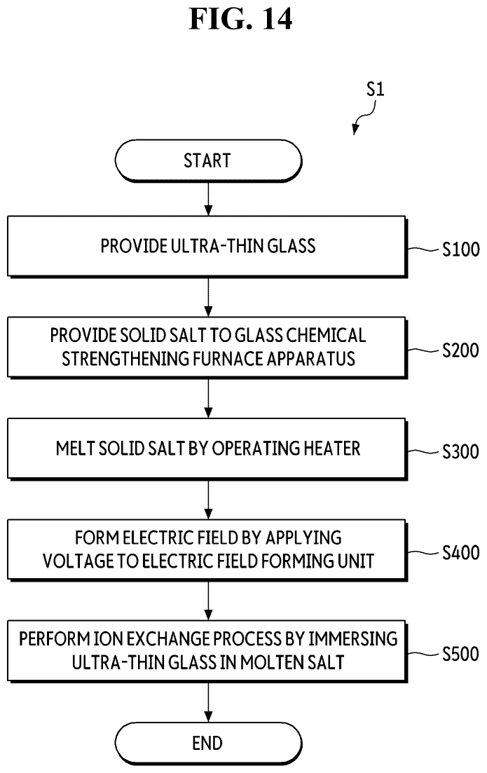

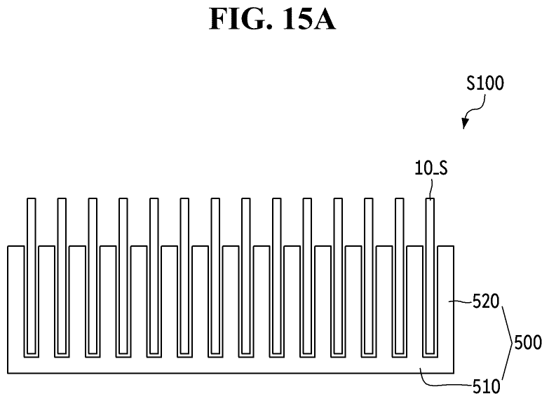

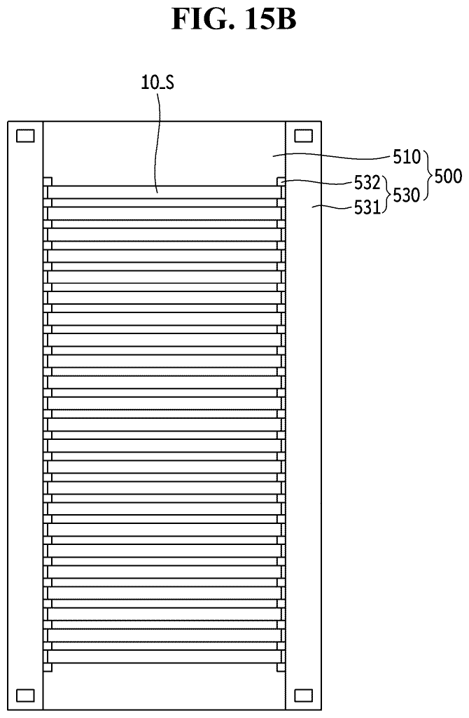

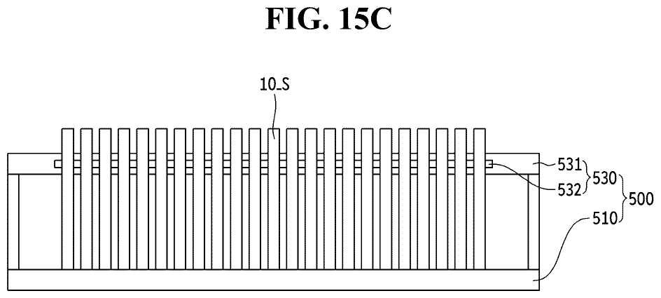

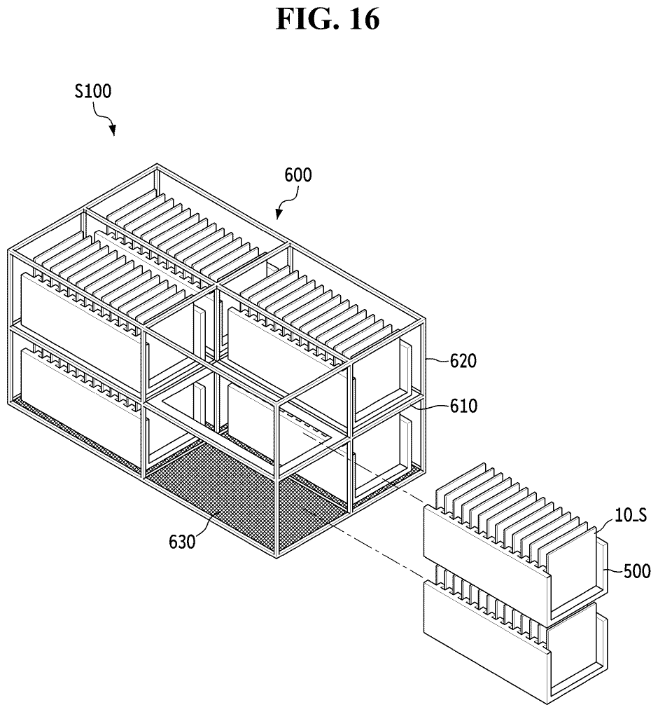

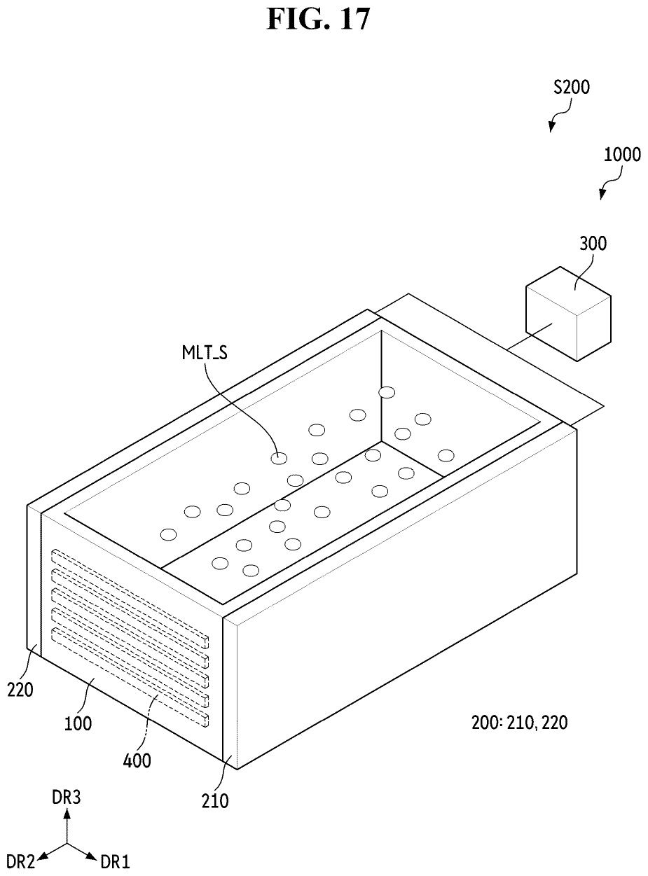

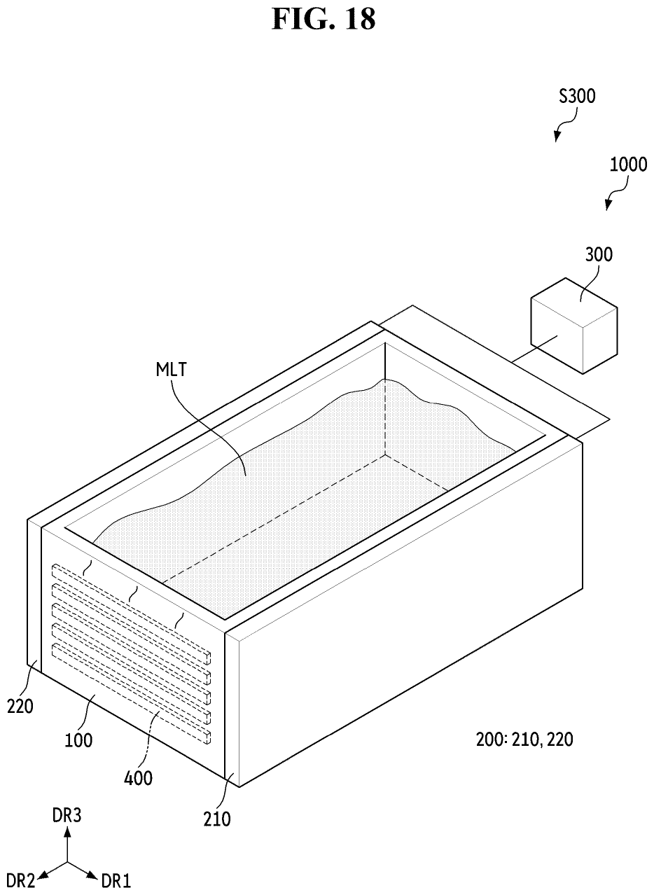

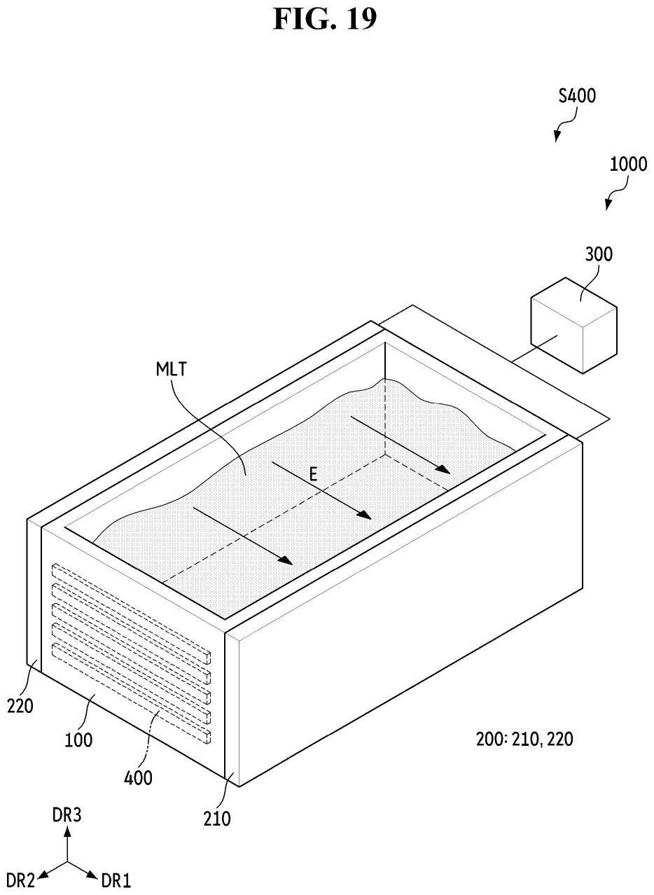

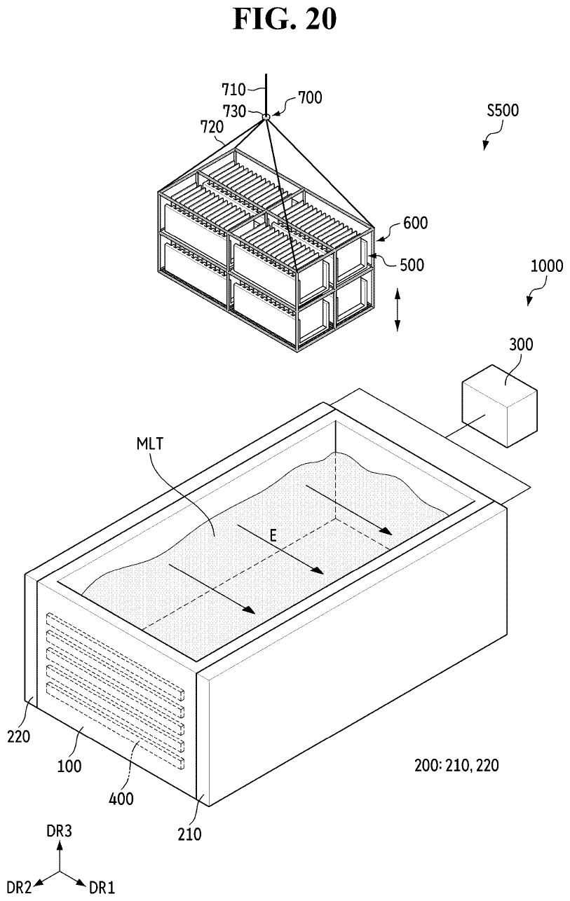

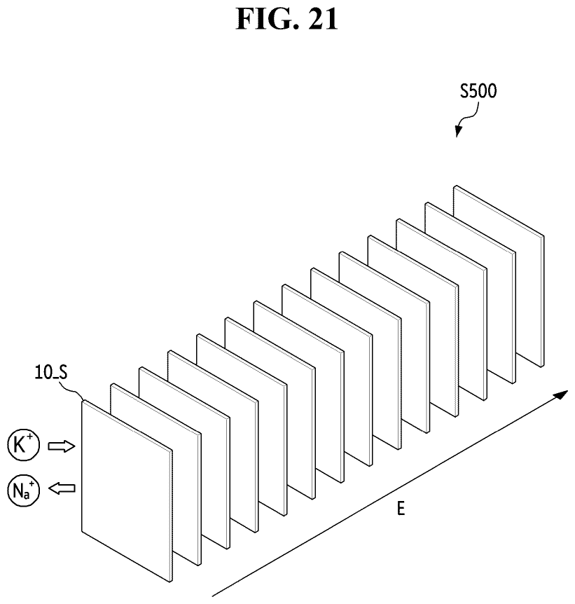

FIG. 14 is a flowchart illustrating a glass chemical strengthening method according to one or more embodiments. FIG. 15A is a cross-sectional view illustrating an example of a cassette utilized in S100 of FIG. 14. FIG. 15B is a plan view illustrating another example of the cassette utilized in S100 of FIG. 14. FIG. 15C is a cross-sectional view illustrating another example of the cassette utilized in S100 of FIG. 14. FIG. 16 is a perspective view illustrating S100 of FIG. 14. FIG. 17 is a perspective view illustrating S200 of FIG. 14. FIG. 18 is a perspective view illustrating S300 of FIG. 14. FIG. 19 is a perspective view illustrating S400 of FIG. 14. FIG. 20 is a perspective view illustrating S500 of FIG. 14. FIG. 21 is a schematic view illustrating an ion exchange process in S500 of FIG. 14.

Referring to FIGS. 14 to 21, a glass chemical strengthening method S1 according to one or more embodiments may include providing an ultra-thin glass (S100), providing a solid salt to a glass chemical strengthening furnace device, referred to as “glass chemical strengthening apparatus” (S200), melting the solid salt by operating a heater (S300), generating/forming an electric field by applying a voltage to an electric field generator (S400), and performing an ion exchange process by immersing the ultra-thin glass in the molten salt (S500).

First, as illustrated in FIGS. 15A, 15B, 15C, and 16, in the providing of the ultra-thin glass (S100), the ultra-thin glass 10_S may be loaded into a cassette 500 and a hanger 600 and transported and processed.

The ultra-thin glass 10_S may be formed through a process of preparing a glass composition and molding the glass composition.

The glass composition may include one or more suitable compositions suitable in the art. The glass composition includes silicon dioxide (SiO₂) as a main component. In addition, the glass composition may include components such as aluminum oxide (Al₂O₃), lithium oxide (LiO₂), and/or sodium oxide (Na2₂), but the present disclosure is not limited thereto, and may further include other components if necessary. In one or more embodiments, the glass composition may include a glass ceramic containing alkali aluminosilicate. In one or more embodiments, the glass composition may include a glass ceramic containing borosilicate.

The glass composition described above may be molded into a glass shape by one or more suitable methods suitable in the art. For example, the glass composition may be molded into the glass shape by a method such as a float process, a fusion draw process, and/or a slot draw process.

The cassette 500 may provide accommodation spaces in which the ultra-thin glasses 10_S are loaded.

In one or more embodiments, as illustrated in FIG. 15A, the cassette 500 may include a lower support 510 and partition walls 520. For example, an accommodation space (e.g., a slot) in which the ultra-thin glass 10_S is loaded may be defined by one side surface of one partition wall 520, the other side surface of another partition wall 520 neighboring to the one partition wall 520 in one side direction, and an upper surface of the lower support 510 connecting the two partition walls 520 described above to each other. The cassette 500 capable of accommodating fourteen ultra-thin glasses 10_S has been illustrated in one or more embodiments of FIG. 15A, but the present disclosure is not limited thereto.

A height of the partition wall 520 of the cassette 500 may be smaller than a length of a long side of the ultra-thin glass 10_S. However, the partition wall 520 may have such a height that contact between the ultra-thin glasses 10_S loaded in accommodation spaces neighboring to each other does not occur.

In one or more embodiments, the partition wall 520 of the cassette 500 may include a material through which the electric field E formed by the glass chemical strengthening furnace device 1000 may pass. For example, the partition wall 520 may include a dielectric such as a glass, a polymer, and/or a ceramic.

In one or more embodiments, as illustrated in FIGS. 15B and 15C, the cassette 500 may include a lower support 510 and a side support 530.

The side support 530 may be arranged on the lower support 510. For example, if (e.g., when) the lower support 510 has a rectangular shape in a plan view, the side support 530 may be arranged on two long sides (left and right sides in FIG. 15B) of four sides of the lower support 510. The side support 530 or other partition walls may not be arranged on two short sides (upper and lower sides in FIG. 15B) of the four sides of the lower support 510.

The side support 530 may include support portions 531 and ribs 532.

The support portions 531 may extend in an upward direction of the lower support 510. The support portions 531 may be configured as two sidewalls opposite to (e.g., facing) each other, but are not limited thereto.

The ribs 532 may be arranged on an inner side surface of the support portion 531. The number of ribs 532 may be plural. The plurality of ribs 532 may be arranged to be spaced and/or apart (e.g., spaced apart or separated) from each other on the inner side surface of the support portion 531. The plurality of ribs 532 may be arranged on the inner side surface of each of two support portions 531 opposite to (e.g., facing) each other, and the ribs 532 opposite to (e.g., facing) each other may be arranged in a row.

An accommodation space (e.g., a slot) in which the ultra-thin glass 10_S is loaded may be defined by two ribs 532 spaced and/or apart (e.g., spaced apart or separated) from each other on the inner side surface of the same support portion 531 and two other ribs 532 opposite to (e.g., facing) the two ribs 532. Accordingly, a partition wall may not be arranged between the ultra-thin glasses 10_S loaded adjacent to each other. Accordingly, the electric field E formed by the glass chemical strengthening furnace device 1000 may suitably pass between the ultra-thin glasses 10_S.

The hanger 600 may provide an accommodation space in which the cassette 500 is loaded. The hanger 600 configured to load eight cassettes 500 by including a frame having three stages in the horizontal direction and three stages in a vertical direction has been illustrated in FIG. 16, but the present disclosure is not limited thereto. The hanger 600 according to one or more embodiments may include a horizontal frame 610, a vertical frame 620, and a wire mesh 630. A space in which the cassette 500 is loaded may be an internal space of each rectangular parallelepiped structure formed by the horizontal frame 610 and the vertical frame 620. The cassette 500 may be supported by the horizontal frame 610 and loaded in the hanger 600.

The wire mesh 630 may be installed at a lower portion of the hanger 600. The wire mesh 630 according to one or more embodiments is a mesh-shaped mesh including (e.g., made of) iron, and may be installed by being coupled to the lowest horizontal frame 610. The wire mesh 630 may filter glass fragments that may occur during chemical strengthening.

Second, as illustrated in FIG. 17, in the providing of the solid salt to the glass chemical strengthening furnace device (S200), the solid salt MLT_S may be provided in the reaction space inside the bath 100 of the glass chemical strengthening furnace device 1000.

The solid salt MLT_S may be a single salt and/or a mixed salt. In one or more embodiments, the solid salt MLT_S may be a salt including a monovalent alkali metal such as sodium (Na), potassium (K), rubidium (Rb), and/or cesium (Cs). For example, the solid salt MLT_S may include potassium nitrate (KNO₃) and/or sodium nitrate (NaNO₃).

Third, as illustrated in FIG. 18, in the melting of the solid salt by operating the heater (S300), the heater 400 may generate heat desired or required to melt the solid-state salt MLT_S. The heat provided from the heater 400 may melt the solid salt MLT_S and maintain a temperature of the molten salt MLT.

Fourth, as illustrated in FIG. 19, in the forming of the electric field by applying the voltage to the electric field generator (S400), the electric field controller 300 may apply the voltage to the electric field generator 200. For example, the electric field controller 300 may apply voltages having different polarities respectively to the first electrode 210 and the second electrode 220 of the electric field generator 200. Accordingly, the electric field E may be formed in the reaction space inside the bath 100 in a direction from the first electrode 210 toward the second electrode 220 or in a direction opposite to the direction from the first electrode 210 toward the second electrode 220.

Fifth, as illustrated in FIGS. 20 and 21, in the performing of the ion exchange process by immersing the ultra-thin glass in the molten salt (S500), the ion exchange process may be performed by loading the cassette 500 loaded with the ultra-thin glass 10_S in the hanger 600, immersing the hanger 600 in the glass chemical strengthening furnace device 1000 in which the molten salt MLT is accommodated, and then taking the hanger 600 out of the glass chemical strengthening furnace device 1000 after a set or predetermined time. The hanger 600 may be reciprocated up and down by a cable 700 (e.g., a cable unit) connected to the hanger 600 and positioned above the hanger 600.

The cable 700 includes a central cable 710, branch cables 720 separated from the central cable 710, and a bundle 730 connecting the central cable 710 and the branch cables 720 to each other. Each branch cable 720 may be connected to the hanger 600, and the central cable 710 may be moved up and down by an elevating device. If (e.g., when) the hanger 600 is immersed in the molten salt MLT accommodated in the glass chemical strengthening furnace device 1000, the cable 700 may be lowered, and if (e.g., when) the hanger 600 is taken out of the molten salt MLT, the cable 700 may be raised. In one or more embodiments, the hanger 600 may be immersed in a direction in which a wide surface of the ultra-thin glass 10_S is normal (e.g., perpendicular) to a progress direction of the electric field E.

While the hanger 600 in which the cassette 500 loaded with the ultra-thin glass 10_S is loaded is immersed in the molten salt MLT, chemical strengthening through the ion exchange process may be performed.

The chemical strengthening may be performed through the ion exchange process. The ion exchange process is a process of exchanging ions inside the ultra-thin glass 10_S with other ions. In one or more embodiments, the ion exchange process may be performed concurrently (e.g., simultaneously) on a plurality of ultra-thin glasses 10_S. For example, an ion exchange may be performed concurrently (e.g., simultaneously) in the plurality of ultra-thin glasses 10_S by immersing the plurality of ultra-thin glasses 10_S in the molten salt MLT accommodated in one glass chemical strengthening furnace device 1000.

Through the ion exchange process, ions on or near a surface of the ultra-thin glass 10_S may be replaced or exchanged with greater ions having the same valence or oxidation state. For example, if (e.g., when) the ultra-thin glass 10_S includes monovalent alkali metal ions such as lithium (Li), sodium (Na), potassium (K), and/or rubidium (Rb) ions, monovalent cations on the surface of the ultra-thin glass 10_S may be exchanged with sodium (Na), potassium (K), rubidium (Rb), and/or cesium (Cs) ions having a greater ionic radius than the monovalent cations.

A chemical strengthening operation/step (e.g., act or task) may be single-salt or mixed-salt wet chemical strengthening by an immersion method. For example, the chemical strengthening operation/step (e.g., act or task) may be performed by immersing the ultra-thin glass 10_S in the molten salt MLT accommodated in the glass chemical strengthening furnace device 1000 and including an alkali metal ion salt, and the alkali metal may include at least one of sodium (Na), potassium (K), rubidium (Rb), and/or cesium (Cs) ions. For example, the chemical strengthening operation/step (e.g., act or task) may be performed by the molten salt MLT of the sodium (Na), potassium (K), rubidium (Rb), and/or cesium (Cs) ions. The wet chemical strengthening is advantageous in terms of mass production and may implement more substantially uniform strengthening characteristics.

In one or more embodiments, the chemical strengthening operation/step (e.g., act or task) utilizes a molten salt MLT such as potassium nitrate (KNO₃) and/or sodium nitrate (NaNO₃), and may be performed at a temperature of the molten salt MLT of about 300° C. to 500° C. for a time in the range of 1 hour to 30 hours. The chemical strengthening operation/step (e.g., act or task) may enable the exchange of alkali ions on a surface layer of the ultra-thin glass 10_S with ions having a great ionic radius.

Through the ion exchange process, ions on or near the surface of the ultra-thin glass 10_S may be replaced or exchanged with greater ions having the same valence or oxidation state. For example, if (e.g., when) the ultra-thin glass 10_S includes monovalent alkali metal ions such as lithium (Li), sodium (Na), potassium (K), and/or rubidium (Rb) ions, monovalent cations on the surface of the ultra-thin glass 10_S may be exchanged with sodium (Na), potassium (K), rubidium (Rb), and/or cesium (Cs) ions having a greater ionic radius than the monovalent cations.

For example, if (e.g., when) the ultra-thin glass 10_S including sodium ions Na⁺ is exposed to potassium ions K⁺ by a method of immersing the ultra-thin glass 10_S in the molten salt MLT including potassium nitrate (KNO₃), the sodium ions Na⁺ inside the ultra-thin glass 10_S may be discharged to the outside and replaced with the potassium ions K⁺. The exchanged potassium ions K⁺ have a greater ionic radius than the sodium ions Na⁺ and thus generate a compressive stress. The greater the amount of the exchanged potassium ions K⁺, the greater the compressive stress. Because an ion exchange is performed through the surface of the ultra-thin glass 10_S, an amount of the potassium ions K⁺ on the surface of the ultra-thin glass 10_S may be the greatest. Some of the exchanged potassium ions K⁺ may increase a compressive depth while diffusing into the inside of the ultra-thin glass 10_S, but an amount of the potassium ions K⁺ may substantially decrease as a distance from the surface increases.

The ultra-thin glass 10_S is chemically strengthened through such an ion exchange process, such that the glass article 10 (see FIG. 1) may be formed. The glass chemical strengthening method S1 according to one or more embodiments described with reference to FIGS. 14 to 21 includes the forming of the electric field by applying the voltage to the electric field generator (S400), and thus, an ion exchange rate in the ion exchange process may be improved. For example, the electric field generator may generate the electric field in the reaction space inside the bath to improve an ion exchange rate in the ion exchange process.

Furthermore, having the polarity switch to change the polarities of the voltages applied to the first electrode and the second electrode may change the direction of the electric field from the first electrode to the second electrode or the other way around, such that the electric field may evenly act on the ultra-thin glass to be chemically strengthened, and therefore, the ion exchange rate of the ion exchange process may be evenly promoted.

Moreover, because the rotation drivers rotate the first electrode and the second electrode, a relative disposition of the protruding portions of the first pattern portion of the first electrode and the protruding portions of the second pattern portion of the second electrode may continuously change. Therefore, the ion exchange rate of the ion exchange process may be evenly promoted by the diversification of the direction of the electric field. As a result, the ultra-thin glass made through the improved ion exchange process may provide an overall evenly-strengthen surface against an impact, a scratch, and/or folding in daily use.

It has been illustrated in FIGS. 14 to 21 that the glass chemical strengthening method S1 according to one or more embodiments is performed in the order of S100, S200, S300, S400, and S500, but the order of S100, S200, S300, S400, and S500 is not limited thereto. For example, S100 may be performed after S200, and S300 or S400 and S500 may be performed concurrently (e.g., simultaneously).

In summary, the present disclosure enhances the manufacturing process when in mass production of an ultra-thin glass and implements more strengthening characteristics (e.g., the improved durability against a scratch and folding) to the ultra-thin glass by utilizing the glass chemical strengthening furnace device according to one or more embodiments of the present disclosure.

Also, an electronic device may include the glass article produced using the glass chemical strengthening furnace device. This glass article offers several advanced features, such as enhanced durability against impacts, scratches, and folding, making it ideal for use in modern portable electronic devices like smartphones and/or tablets. The improved ion exchange process ensures a uniformly strengthened glass surface, providing superior performance and longevity in daily use. This advancement in glass technology significantly contributes to the overall robustness and reliability of electronic devices.

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

In the context of the present disclosure and unless otherwise defined, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The furnace apparatus/device, the electronic apparatus/device, the manufacturing apparatuses thereof, or any other relevant apparatuses/devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In concluding the detailed description, those skilled in the art will appreciate that many variations and modifications may be made to one or more embodiments of the present application without substantially departing from the principles of the present disclosure. Therefore, the disclosed embodiments of the present disclosure are utilized in a generic and descriptive sense only and not for purposes of limitation.

While one or more embodiments of the present disclosure have been described above, a person ordinarily skilled in the art to which the present disclosure pertains shall appreciate that there may be a variety of modifications and permutations of the present disclosure without departing from the technical ideas and scopes of the present disclosure and equivalents thereof that are defined in the appended claims. Moreover, it shall be appreciated that the one or more embodiments of the present disclosure are not intended to restrict the present disclosure thereto and that every technical idea within the appended claims and their equivalents is interpreted to be included in the scope of the present disclosure and equivalents thereof.

What is claimed is:

1. A glass chemical strengthening furnace device comprising:
a bath;
a first electrode on one side of the bath; and
a second electrode on another side of the bath and opposite to the first electrode,
wherein the first electrode is arranged to be separated from the second electrode with the bath therebetween.

2. The glass chemical strengthening furnace device of claim 1, further comprising a power supply configured to apply a voltage to the first electrode and the second electrode.

3. The glass chemical strengthening furnace device of claim 2, wherein a magnitude of the voltage applied to the first electrode and the second electrode by the power supply is 5 V to 2000 V.

4. The glass chemical strengthening furnace device of claim 1, further comprising a polarity switch configured to change a polarity of a voltage applied to the first electrode and the second electrode.

5. The glass chemical strengthening furnace device of claim 4, wherein the polarity switch comprises at least one of an H-bridge circuit or a double-pole double-throw (DP DT) switch.

6. The glass chemical strengthening furnace device of claim 1, wherein
the first electrode comprises a first pattern portion,
the second electrode comprises a second pattern portion, and
the first pattern portion is opposite to the second pattern portion.

7. The glass chemical strengthening furnace device of claim 6, wherein the first pattern portion is opposite to the second pattern portion with the bath therebetween.

8. The glass chemical strengthening furnace device of claim 6, wherein the first pattern portion and the second pattern portion comprise a protruding portion and a recessed portion respectively.

9. The glass chemical strengthening furnace device of claim 8, wherein the protruding portion of the first pattern portion and the protruding portion of the second pattern portion are positioned in a straight line.

10. The glass chemical strengthening furnace device of claim 8, wherein the protruding portion of the first pattern portion and the protruding portion of the second pattern portion are staggered.

11. The glass chemical strengthening furnace device of claim 10, wherein the protruding portion of the first pattern portion and the recessed portion of the second pattern portion are positioned in a straight line.

12. The glass chemical strengthening furnace device of claim 1, further comprising:
a first rotation driver fastened to the first electrode; and
a second rotation driver fastened to the second electrode.

13. The glass chemical strengthening furnace device of claim 1, wherein the glass chemical strengthening furnace device is configured to form an electric field between the first electrode and the second electrode.

14. The glass chemical strengthening furnace device of claim 1, wherein the bath comprises an insulating material and a dielectric.

15. A glass chemical strengthening furnace device comprising:
a bath in which a reaction space is defined;
an electric field generator configured to form an electric field in the reaction space of the bath; and
an electric field controller configured to apply a voltage to the electric field generator,
wherein the electric field generator comprises a first electrode and a second electrode respectively on opposite sides of the bath.

16. The glass chemical strengthening furnace device of claim 15, wherein the electric field controller comprises a power supply configured to apply a voltage to the first electrode and the second electrode.

17. The glass chemical strengthening furnace device of claim 15, wherein the electric field controller comprises a polarity switching configured to change a polarity of a voltage applied to the first electrode and the second electrode.

18. The glass chemical strengthening furnace device of claim 15, wherein
the first electrode comprises a first pattern portion,
the second electrode comprises a second pattern portion, and
the first pattern portion is opposite to the second pattern portion.

19. The glass chemical strengthening furnace device of claim 15, further comprising:
a first rotation driver fastened to the first electrode; and
a second rotation driver fastened to the second electrode.

20. An electronic device comprising or being formed with a glass chemical strengthening furnace device, the glass chemical strengthening furnace device comprising:
a bath;
a first electrode on one side of the bath; and
a second electrode on the other side of the bath and opposite to the first electrode,
wherein the first electrode is arranged to be separated from the second electrode with the bath therebetween.
